(19) United States
(12) Patent Application Publication
(10) Pub. No.: US 2019/0126982 A1
(43) Pub. Date: May 2, 2019

(54) Adjustable Tie Rod Assemblies and Methods

(71) Applicant: Fleet Pride, Inc., Irving, TX (US)

(72) Inventor: Brian F. Boyd, Flower Mound, TX (US)

(21) Appl. No.: 15/796,566

(22) Filed: Oct. 27, 2017

(51) Int. Cl. B62D 17/00; B62D 7/20

(52) U.S. Cl. CPC B62D 17/00; B60G 2206/1112; B62D 7/20

(57) ABSTRACT

In one instance an adjustable tie rod assembly suitable for use with a heavy duty truck has the ability to be adjusted with respect to its length such that only one size of the device need be stocked by a store or service center and, yet, because of its adjustability, it will accommodate a tremendous number of vehicles. The adjustable tie rod assembly includes an adjustable tie rod assembly having a first hollow tie rod shaft member, a second hollow tie rod shaft member, and a tie rod connecting member. Other embodiments are included.

### TECHNICAL FIELD

This application is directed, in general, to components, systems, and methods related to steering heavy duty trucks, and more specifically, to adjustable tie rod assemblies and methods.

### BACKGROUND

Heavy duty trucks, e.g., “semi trucks,” include steering wheels in the cabin that couple through a steering shaft to a steering box and then to one front wheel, e.g., the left front wheel. The left wheel is coupled to the right front wheel by a cross tube, or tie rod or rod shaft. The cross tube has tie rod ends on each side. The tie rod ends couple the cross tube to a steering knuckle on each side.

Maintaining the cross tube, or tie rod, and the tie rod ends in good shape is an important aspect of maintaining heavy duty trucks. If the cross tube and tie rod ends are not well maintained it can lead to uneven tire wear, looseness or knocks in the steering system, non-straight driving, etc. As such, the tie rod ends and cross tube are regularly inspected and at times need to be replaced.

### SUMMARY

According to an illustrative embodiment, an adjustable tie rod assembly for use with a heavy duty truck, the adjustable tie rod assembly comprising an adjustable tie rod, the adjustable tie rod comprising: a first hollow tie rod shaft member, a second hollow tie rod shaft member, and a tie rod connecting member. The first hollow tie rod shaft member has a first end and a second end. The first hollow tie rod has an internal surface. The first hollow tie rod shaft member includes first internal threads formed on the internal surface proximate the first end, and wherein the first hollow tie rod shaft member comprises second internal threads formed on the internal surface proximate the second end.

The second hollow tie rod shaft member has a first end and a second end. The second hollow tie rod has an internal surface. The second hollow tie rod shaft member includes first internal threads formed on the internal surface proximate the first end. The second hollow tie rod shaft member includes second internal threads formed on the internal surface proximate the second end and includes a tie rod connecting member sized and configured to be inserted at least partially into the second end of the first hollow tie rod shaft member and at least partially into the first end of the second hollow tie rod shaft member. The tie rod connecting member has an external surface and having a first end and a second end, wherein the tie rod connecting member has first connecting threads formed on the external surface of the tie rod connecting member sized and configured to mate with the second internal threads of the second end of the first hollow tie rod. The tie rod connecting member has second connecting threads formed on the external surface of the tie rod connecting member that are sized and configured to mate with the first internal threads of the first end of the second hollow tie rod; a first fastener for securing the first end of the tie rod connecting member to the second end of the first hollow tie rod shaft member; a second fastener for securing the second end of the tie rod connecting member to the first end of the second hollow tie rod shaft member. The first fastener and second fastener are each selected from the group of a jam nut, a compressible clamp, and a dowel pin.

According to an illustrative embodiment, an adjustable tie rod assembly includes a first hollow tie rod shaft member having a first end and a second end and hollow at least proximate the first end and the second end. The first hollow tie rod has an internal surface proximate at least the first end and the second end. The first hollow tie rod shaft member includes first internal threads formed on the internal surface proximate the first end. The adjustable tie rod assembly includes a second hollow tie rod shaft member having a first end and a second end and hollow at least proximate the first end and the second end. The first hollow tie rod has an internal surface proximate at least the first end and the second end. The second hollow tie rod shaft member comprises internal threads formed on the internal surface proximate the second end. The adjustable tie rod assembly further includes a tie rod connecting member sized and configured to be inserted at least partially into the second end of the first hollow tie rod shaft member and at least partially into the first end of the second hollow tie rod shaft member. The adjustable tie rod assembly also includes a first attachment device that couples the first end of the tie rod connecting member to the second end of the first hollow tie rod shaft member and a second attachment device that couples the second end of the tie rod connecting member to the first end of the second hollow tie rod shaft member.

According to another illustrative embodiment, a method replacing a tie rod assembly of a vehicle having a first tie rod connection point associated with a first wheel and a second tie rod connection point associated with a second wheel, the method includes providing an adjustable tie rod assembly comprising a first hollow tie rod shaft member, a second hollow tie rod shaft member, and a tie rod connecting member that together in an assembled position form an adjustable cross tube, wherein the first hollow tie rod shaft member is adjustably coupled to the tie rod connecting member and the tie rod connecting member is adjustably coupled the second hollow tie rod shaft member to form the adjustable cross tube; coupling a first tie rod end member to the first end of the first hollow tie rod shaft member. The method also includes coupling a second tie rod end member to the second end of the second hollow tie rod shaft member; adjusting a length of the adjustable cross tube by moving the tie rod connecting member into or out of the first hollow tie rod shaft member or the second hollow tie rod shaft member in order to accommodate a distance between the first tie rod connection point and the second tie rod connection point; coupling the first tie rod end member to the first tie rod connection point of the vehicle; and coupling the second tie rod end member to the second tie rod connection point of the vehicle.

According to one illustrative embodiment, an adjustable tie rod assembly for use with a heavy duty truck has the ability to be adjusted with respect to its length such that only one size of the device needs to be stocked by a store or service center and, yet, because of its adjustability it will accommodate a tremendous number of vehicles. The adjustable tie rod assembly includes an adjustable tie rod assembly having a first hollow tie rod shaft member, a second hollow tie rod shaft member, and a tie rod connecting member. Other embodiments are presented.

### DESCRIPTION OF THE DRAWINGS

Illustrative embodiments of the present invention are described in detail below with reference to the attached drawing figures, which are incorporated by reference herein and wherein:

FIG. 1 is a schematic perspective view of an illustrative embodiment of a tie rod assembly;

FIG. 2 is a schematic elevation view of an adjustable tie rod assembly suitable for use with a heavy duty truck;

FIG. 3 is a schematic, exploded elevation view in cross section of a portion of an adjustable tie rod assembly;

FIG. 4 is a schematic cross-section of the second end of a first hollow tie rod shaft member mated with a first end of a tie rod connecting member of an adjustable tie rod assembly;

FIG. 5 is a schematic perspective view of the second end of a first hollow tie rod shaft member mated with a first end of a tie rod connecting member of an adjustable tie rod assembly according to another embodiment; and

FIG. 6 is a schematic elevation view of another adjustable tie rod assembly suitable for use with a heavy duty truck.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims. Unless otherwise indicated, as used throughout this document, “or” does not require mutual exclusivity.

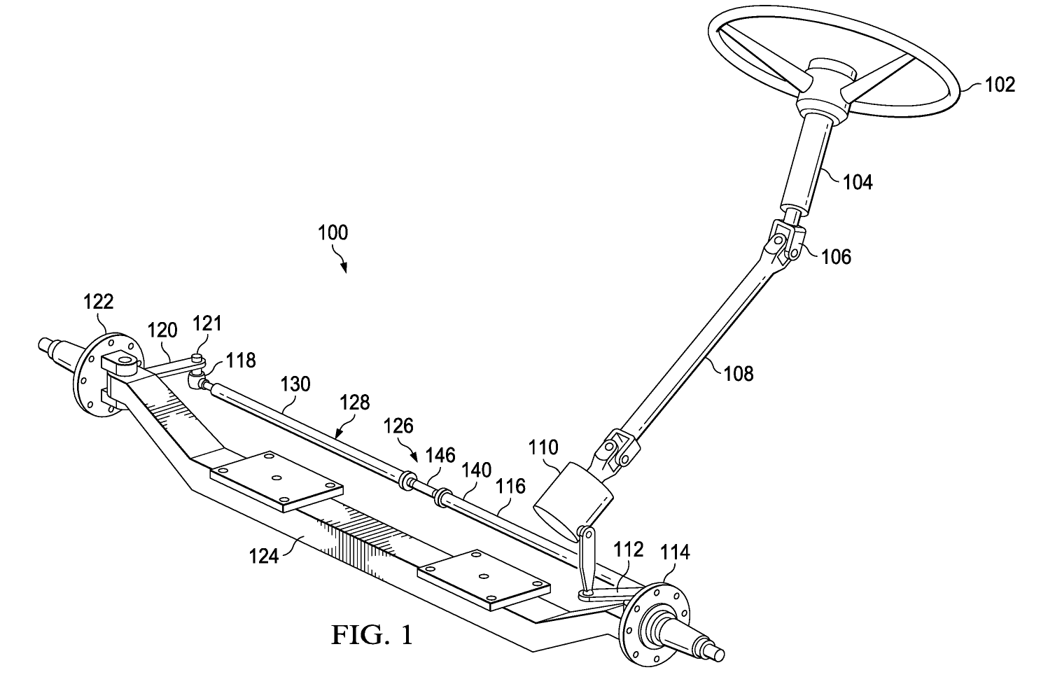

Referring now to the drawings and initially to FIG. 1, an illustrative embodiment of an adjustable tie rod assembly 100 is presented. FIG. 1 is primarily to provide high-level context. Those skilled in the art will understand that there are many variations and permutations on the context in which the tie rod assemblies of the present disclosure might be used. The tie rod assembly 100 is suitable for use with heavy duty trucks, e.g., semi trucks, and is found at the front with the two wheels that are controlled from within the cabin. In most instances, the steering wheel 102 that is in the cabin of the truck is coupled by a steering column 104 to one or more joints 106 to a steering shaft 108 and to a steering box 110. The steering box 110 is coupled to a steering arm 112 that couples to the spindle/wheel 114. A steering knuckle is coupled to a tie rod end member (not explicitly shown in FIG. 1) that is coupled to a cross tube or straight tie rod 116.

The cross tube 116 extends across to another tie rod end member 118, which is coupled to a steering knuckle 120 at a tie rod connection point 121. The steering knuckle 120 is associated with the other spindle/wheel 122. The cross tube 116 extends substantially parallel to the suspension 124 that extends between the spindles on each side.

After the vehicle has been on the road for many miles, the tie rod or cross tube 116 may wear out or otherwise need to be replaced. In the past, the new cross tube 116 that was exactly the correct size to extend between the tie rod connection points was required to be stocked. In contrast, the present disclosure contemplates an adjustment configuration 126 on the cross tube 116 that allows the length to be adjusted before installation. In this way, only one type or size of cross tube may necessary at a service center or supply store. This helps reduce the stock required. At the same time, the designs herein allow any tie rod end member 118 to be used since variation in length may be accommodated by the adjustment configuration 126.

Referring now to FIGS. 1-3, the cross tube 116 is an adjustable tie rod. The cross tube 116 is used with the first tie rod end member 118 and the second tie rod end member 164 to form an adjustable tie rod assembly 128. The adjustable tie rod 128 is well suited for use with heavy duty trucks.

The adjustable tie rod assembly 128 includes a first hollow tie rod shaft member 130 having a first end 132 and a second end 134. The first hollow tie rod shaft member 130 has an internal surface 136 (FIG. 3), wherein the first hollow tie rod shaft member 130 includes first internal threads (not explicitly shown but analogous to 138) formed on the internal surface proximate the first end 132. The first hollow tie rod shaft member 130 includes second internal threads 138 formed on the internal surface 136 proximate the second end 134.

The adjustable tie rod assembly 128 also includes a second hollow tie rod shaft member 140 having a first end 142 and a second end 144. The second hollow tie rod shaft member 140 has an internal surface (analogous to 136), wherein the second hollow tie rod shaft member 140 includes first internal threads formed on the internal surface proximate the first end 142. The second hollow tie rod shaft member 140 also includes second internal threads (analogous to 138) formed on the internal surface proximate the second end 144.

The adjustable tie rod assembly 128 also includes a tie rod connecting member 146 sized and configured to be inserted at least partially into the second end 134 of the first hollow tie rod shaft member 130 and at least partially into the first end 142 of the second hollow tie rod shaft member 140. The tie rod connecting member 146 has an external surface 148. The tie rod connecting member 146 has a first end 150 and a second end 152. The tie rod connecting member 146 has first connecting threads 154 formed on the external surface 148 of the tie rod connecting member 146 that are sized and configured to mate with the second internal threads 138 of the second end 134 of the first hollow tie rod 130. The tie rod connecting member 146 has second connecting threads 156 formed on the external surface 148 of the tie rod connecting member 146 that are sized and configured to mate with the first internal threads of the first end 142 of the second hollow tie rod shaft member 140.

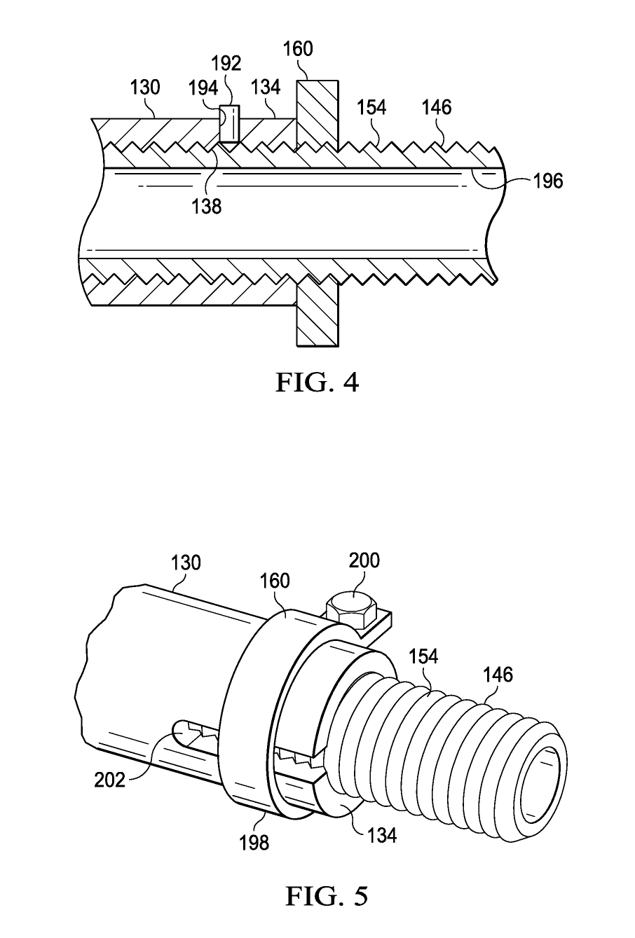

The adjustable tie rod assembly 128 includes a first fastener 160 for securing the first end 150 of the tie rod connecting member 146 to the second end 134 of the first hollow tie rod shaft member 130. The adjustable tie rod assembly 128 includes also a second fastener 162 for securing the second end 152 of the tie rod connecting member 146 to the first end 142 of the second hollow tie rod shaft member 140. The first fastener 160 and second fastener 162 are each selected from the group of a jam nut, a compressible clamp (analogous to clamps 190, 192), and a dowel pin (see 192 in FIG. 4). In some embodiments, two or more of the fasteners mentioned above may be used.

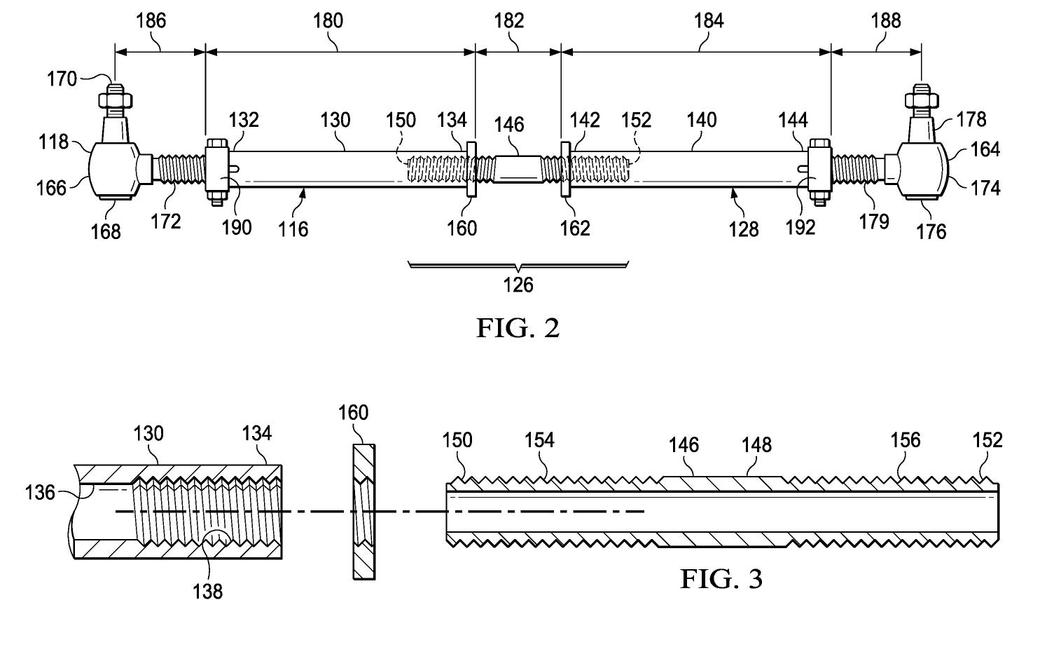

Continuing to refer to FIGS. 1-3, and particularly, to FIG. 2, the adjustable tie rod assembly 128 includes the first tie rod end member 118 and a second tie rod end member 164 for coupling to the steering knuckles, e.g., steering knuckle 120. The first tie rod end member 118 includes a first tie rod body 166 having a first bearing member 168, a end portion 170 extending from the first bearing member 168, and a first tie rod coupling member 172 extending from the bearing member 168. The first tie rod coupling member 172 is sized and configured to mate with the first end 132 of the first hollow tie rod shaft member 130.

Likewise, the second tie rod end member 164 includes a second tie rod body 174 having a second bearing member 176, a second end portion 178 extending from the second bearing member 176, and a second tie rod coupling member 179 extending from the second bearing member 176. The second tie rod coupling member 179 is sized and configured to mate with the second end 144 of the second hollow tie rod shaft member 140.

Referring now particularly to FIG. 2, the first hollow tie rod shaft member 130 has a length 180. The tie rod connecting member 146 outside of the first hollow tie rod shaft member 130 and outside the second hollow tie rod shaft member 140 has a length 182. The second hollow tie rod shaft member 140 has a length 184. The distance between the first end portion 170 and the extreme first end 132 of the first hollow tie rod shaft member 130 is 186. Similarly, the distance between the second end portion 178 and the extreme second end 144 of the second hollow tie rod shaft member 140 is 188. Thus, the overall length from first end portion to send end portion in the assembled position is found by adding the lengths, e.g., 186+180+182+184+188. The length without the tie rod ends is 180+182+184. Each of the first hollow tie rod shaft member 130 and the second hollow tie rod shaft member 140 may have a length 180 and 184, respectively, between 15 and 30 inches and wherein the exposed portion (i.e., not inside the shaft members 130, 140) of the tie rod connecting member 146 typically has a length between 3 and 17 inches. In an assembled position, the first hollow tie rod shaft member 130, the second hollow tie rod shaft member 140, and tie rod connecting member 146 have a combined length between 48 and 65.5 inches. It should be noted that mating of the first tie rod coupling member 172 to the first end 132 of the first hollow tie rod shaft member 130 provides for additional adjustment possibilities. The same is true at the other end, i.e., for the second tie rod coupling member 178 and the second end 144.

The first tie rod end member 118 may be secured or further secured to the first hollow tie rod shaft member 130 with a fastener, for example, without limitation, clamp 190, mating screws, or jam nuts. Likewise, the second tie rod end member 164 may be secured or further secured to the second hollow tie rod shaft member 140 with a fastener, for example, without limitation, clamp 192, mating screws, or jam nuts. In the commercial setting, the tie rod end members 118, 164 would typically be sold separately from the cross tube or tie rod 116.

Referring now primarily to FIG. 4, a detail is presented of one embodiment of the second end 134 of the first hollow tie rod shaft member 130 coupled to the tie rod connecting member 146 with a first fastener 160. A dowel pin 192 is shown in aperture 194 through the first hollow tie rod shaft member 130. The first connecting threads 154 of the tie rod connecting member 146 mate with internal threads 138 of the first hollow tie rod shaft member 130. The tie rod connecting member 146 is shown has having a hollow interior 196, but it could be solid in other embodiments. It should be noted that in some embodiments the first connecting threads 154 of the tie rod connecting member 146 are the same as the second connecting threads 156.

According to one illustrative embodiment, an adjustable tie rod assembly 100 includes a first hollow tie rod shaft member 130 having a first end 132 and a second end 134 and hollow at least proximate the first end 132 and the second end 134. The first hollow tie rod shaft member 130 has an internal surface 136 proximate at least the first end 132 and the second end 134, wherein the first hollow tie rod shaft member 130 includes first internal threads 138 formed on the internal surface proximate the first end 132. The adjustable tie rod assembly 100 further includes a second hollow tie rod shaft member 140 having a first end 142 and a second end 144 and hollow at least proximate the first end 142 and the second end 144.

The second hollow tie rod shaft member 140 has an internal surface proximate at least the first end 142 and the second end 144, wherein the second hollow tie rod shaft member 140 includes internal threads analogous to threads 138 that are formed on the internal surface proximate the second end 144. The adjustable tie rod assembly 100 further includes a tie rod connecting member 146 sized and configured to be inserted at least partially into the second end 134 of the first hollow tie rod shaft member 130 and at least partially into the first end 142 of the second hollow tie rod shaft member 140. It also includes a first attachment device or fastener 160 that couples the first end 150 of the tie rod connecting member 146 to the second end 134 of the first hollow tie rod shaft member 130. Finally, a second attachment device or fastener 162 couples the second end 152 of the tie rod connecting member 146 to the first end 142 of the second hollow tie rod shaft member 140.

According to another illustrative embodiment, a method replacing a tie rod assembly of a vehicle having a first tie rod connection point associated with a first wheel and a second tie rod connection point 121 associated with a second wheel 122, the method includes providing an adjustable tie rod assembly 100 including a first hollow tie rod shaft member 130, a second hollow tie rod shaft member 140, and a tie rod connecting member 146 that together in an assembled position form an adjustable cross tube 116, wherein the first hollow tie rod shaft member 130 is adjustably coupled to the tie rod connecting member 146 and the tie rod connecting member 146 is adjustably coupled to the second hollow tie rod shaft member 140 to form the adjustable cross tube 116; coupling a first tie rod end member 118 to the first end 132 of the first hollow tie rod shaft member 130. The method also includes coupling a second tie rod end member 164 to the second end 144 of the second hollow tie rod shaft member 140; adjusting a length of the adjustable cross tube 116 by moving the tie rod connecting member 146 into or out of the first hollow tie rod shaft member 130 or the second hollow tie rod shaft member 140 in order to accommodate a distance between the first tie rod connection point 121 and the second tie rod connection point (mirror of 121 on other side); coupling the first tie rod end member 118 to the first tie rod connection point 121 of the vehicle; and coupling the second tie rod end member to the second tie rod connection point of the vehicle.

Referring now primarily to FIG. 5, another first fastener 160 for coupling the first hollow tie rod shaft member 130 to the tie rod connecting member 146 is presented. The fastener 160 in this embodiment is a clamp member 198 having a securing bolt 200. To facilitate pinching of the tie rod connecting member 146, one or more flex channels 202 may be added.

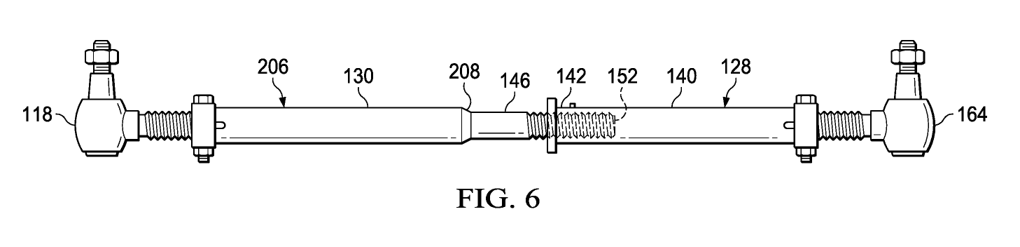

Referring now primarily to FIG. 6, an alternative embodiment of a cross tube or straight tie rod 206 is presented. The cross tube 206 is analogous to those previously presented and so some part numbers are labeled but not further referenced. In this instance the main difference is that the first hollow tie rod shaft member 130 and the tie rod connecting member 146 are formed as an integral piece. The two parts 130, 146 are transitioned with a transition area 208.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed:

1. An adjustable tie rod assembly for use with a heavy duty truck, the adjustable tie rod assembly comprising an adjustable tie rod, the adjustable tie rod comprising:
a first hollow tie rod shaft member having a first end and a second end, wherein the first hollow tie rod has an internal surface, wherein the first hollow tie rod shaft member comprises first internal threads formed on the internal surface proximate the first end, and wherein the first hollow tie rod shaft member comprises second internal threads formed on the internal surface proximate the second end;
a second hollow tie rod shaft member having a first end and a second end, wherein the second hollow tie rod has an internal surface, wherein the second hollow tie rod shaft member comprises first internal threads formed on the internal surface proximate the first end, and wherein the second hollow tie rod shaft member comprises second internal threads formed on the internal surface proximate the second end;
a tie rod connecting member sized and configured to be inserted at least partially into the second end of the first hollow tie rod shaft member and at least partially into the first end of the second hollow tie rod shaft member, the tie rod connecting member having an external surface and having a first end and a second end, wherein the tie rod connecting member has first connecting threads formed on the external surface of the tie rod connecting member sized and configured to mate with the second internal threads of the second end of the first hollow tie rod, and wherein the tie rod connecting member has second connecting threads formed on the external surface of the tie rod connecting member that are sized and configured to mate with the first internal threads of the first end of the second hollow tie rod;
a first fastener for securing the first end of the tie rod connecting member to the second end of the first hollow tie rod shaft member;
a second fastener for securing the second end of the tie rod connecting member to the first end of the second hollow tie rod shaft member; and
wherein the first fastener and second fastener are each selected from the group of a jam nut, a compressible clamp, and a dowel pin.

2. The adjustable tie rod assembly of claim 1, further comprising:
a first tie rod end member comprising: a first tie rod body having a first bearing member, a first end portion extending from the first bearing member, and a first tie rod coupling member extending from the bearing member, the first tie rod coupling member sized and configured to mate with the first end of the first hollow tie rod shaft member; and
a second tie rod end member comprising: a second tie rod body having a second bearing member, a second end portion extending from the second bearing member, and a second tie rod coupling member extending from the second bearing member, the second tie rod coupling member sized and configured to mate with the second end of the second hollow tie rod shaft member.

3. The adjustable tie rod assembly of claim 1, wherein each of the first hollow tie rod shaft member and the second hollow tie rod shaft member have a length between 15 and 30 inches and wherein the tie rod connecting member has a length between 3 and 17 inches.

4. The adjustable tie rod assembly of claim 1, wherein, in an assembled position, the first hollow tie rod shaft member, the second hollow tie rod shaft member, and tie rod connecting member have a combined length between 48 and 65.5 inches.

5. The adjustable tie rod assembly of claim 1, wherein the first fastener and second fastener each comprise a jam nut and a dowel pin.

6. The adjustable tie rod assembly of claim 2, further comprising:
a first clamp positioned proximate the first end of the first hollow tie rod shaft member for coupling the first tie rod coupling member of the first tie rod end member to the first hollow tie rod shaft member; and
a second clamp positioned proximate the second end of the second hollow tie rod shaft member for coupling the second tie rod coupling member of the second tie rod end member to the second hollow tie rod shaft member.

7. The adjustable tie rod assembly of claim 1, wherein the first internal threads and second internal threads of the first hollow tie rod shaft member comprise one set of threads.

8. An adjustable tie rod assembly comprising:
a first hollow tie rod shaft member having a first end and a second end and hollow at least proximate the first end and the second end, wherein the first hollow tie rod has an internal surface proximate at least the first end and the second end, wherein the first hollow tie rod shaft member comprises first internal threads formed on the internal surface proximate the first end;
a second hollow tie rod shaft member having a first end and a second end and hollow at least proximate the first end and the second end, wherein the first hollow tie rod has an internal surface proximate at least the first end and the second end, wherein the second hollow tie rod shaft member comprises internal threads formed on the internal surface proximate the second end;
a tie rod connecting member sized and configured to be inserted at least partially into the second end of the first hollow tie rod shaft member and at least partially into the first end of the second hollow tie rod shaft member;
a first attachment device that couples the first end of the tie rod connecting member to the second end of the first hollow tie rod shaft member; and
a second attachment device that couples the second end of the tie rod connecting member to the first end of the second hollow tie rod shaft member.

9. The adjustable tie rod assembly of claim 8, wherein first attachment device comprises mating threads on an interior surface of the first hollow tie rod shaft member proximate the second end and complimentary threads formed on an exterior of the tie rod connecting member proximate the first end.

10. The adjustable tie rod assembly of claim 9, wherein the first attachment device further comprises a jam nut.

11. The adjustable tie rod assembly of claim 10, wherein the first attachment device further comprises a dowel pin positioned proximate the second end of the first hollow tie rod shaft member and the first end of the tie rod connecting member.

12. An adjustable tie rod assembly for use with a heavy duty truck, the adjustable tie rod assembly comprising:
a first hollow tie rod shaft member having a first end and a second end, wherein the first hollow tie rod is formed with a first hollow portion proximate the first end, and wherein the first hollow portion has an internal surface, wherein the first hollow tie rod shaft member comprises first internal threads formed on the internal surface proximate the first end;
a second hollow tie rod shaft member having a first end and a second end, wherein the second hollow tie rod shaft member has an internal surface, wherein the second hollow tie rod shaft member comprises first internal threads formed on the internal surface proximate the first end, and wherein the second hollow tie rod shaft member comprises second internal threads formed on the internal surface proximate the second end;
a tie rod connecting member formed on the second end of the first hollow tie rod shaft member, wherein the tie rod connecting member has a first end and second end, and wherein the second end of the first hollow tie rod shaft member comprises the first end of the tie rod connecting member;
wherein the second end of the tie rod connecting member is sized and configured to mate with the first end of the second hollow tie rod shaft member; and
a fastener for attaching the second end of the tie rod connecting member and the first end of the second hollow tie rod shaft member.

13. A method replacing a tie rod assembly of a vehicle having a first tie rod connection point associated with a first wheel and a second tie rod connection point associated with a second wheel, the method comprising:
providing an adjust adjustable tie rod assembly comprising a first hollow tie rod shaft member, a second hollow tie rod shaft member, and a tie rod connecting member that together in an assembled position form an adjustable cross tube, wherein the first hollow tie rod shaft member is adjustably coupled to the tie rod connecting member and the tie rod connecting member is adjustably coupled the second hollow tie rod shaft member to form the adjustable cross tube;
coupling a first tie rod end member to the first end of the first hollow tie rod shaft member;
coupling a second tie rod end member to the second end of the second hollow tie rod shaft member;
adjusting a length of the adjustable cross tube by moving the tie rod connecting member into or out of the first hollow tie rod shaft member or the second hollow tie rod shaft member in order to adjust accommodate a distance between the first tie rod connection point and the second tie rod connection point;
coupling the first tie rod end member to the first tie rod connection point of the vehicle; and
coupling the second tie rod end member to the second tie rod connection point of the vehicle.
